(19) United States
(12) Patent Application Publication
(10) Pub. No.: US 2024/0376948 A1
(43) Pub. Date: Nov. 14, 2024

(54) ELECTROMECHANICAL BRAKE, BRAKE SHOE AND BRAKE SHOE UNIT

(71) Applicants: ZF Active Safety GmbH, Koblenz (DE); ZF Steering Systems Poland Sp. z.o.o, Czechowice-Dziedzice (PL)

(72) Inventors: Thomas Klug, Koblenz (DE); Matthias Funk, Neuwied (DE); Tomasz Rusin, Czechowice-Dziedzice (PL)

(21) Appl. No.: 18/659,481

(22) Filed: May 9, 2024

(30) Foreign Application Priority Data
May 10, 2023 (DE) 102023112350.5

(51) Int. Cl. F16D 66/02; B60T 17/22; F16D 55/226; F16D 65/092; F16D 66/00

(52) U.S. Cl. CPC F16D 66/021; B60T 17/22; F16D 55/226; F16D 65/092; F16D 2066/001; F16D 2066/005

(57) ABSTRACT

An electromechanical brake for a vehicle, has an actuating element, which is accommodated on a brake calliper in a linearly displaceable manner and cooperates with a brake shoe which can be moved towards a brake disc. A sensor element is arranged in a region of the brake shoe. The sensor element is designed such that it transfers data to a control unit of the electromechanical brake. The sensor element comprises at least one mechanical-electrical converter. A brake shoe for the electromechanical brake has a rigid backplate and a brake pad connected to the backplate in a fixed manner. The sensor element is arranged between the backplate and the brake pad. A brake shoe unit for the electromechanical brake has a carrier plate on which the sensor element is arranged, which sensor element is connected to the backplate of the brake shoe in a fixed manner.

### TECHNICAL FIELD

The disclosure relates to an electromechanical brake, and in particular of a vehicle, and a brake shoe and a brake shoe unit for such a brake.

### BACKGROUND

Electromechanical brakes typically comprise an actuator assembly having a linearly displaceable brake piston, which is guided in a brake calliper unit and serves for applying a brake pad to a brake rotor, also known as a brake disc. To this end, the brake piston is moved via a spindle drive, for example.

It is desirable here to determine the brake force generated between the brake pad and the brake disc as precisely as possible. However, the use of force sensors on the brake piston is complex and expensive.

### SUMMARY

What is needed is for a brake force to be determined in a simple and cost-effective manner.

An exemplary arrangement of an electromechanical brake, for example for a motor vehicle, is disclosed. The brake has an actuating element, which is accommodated on a brake calliper in a linearly displaceable manner and cooperates with a brake shoe which can be moved towards a brake disc, wherein a sensor element is arranged in the region of the brake shoe. The sensor element is designed such that it transfers data to a control unit of the electromechanical brake. The sensor element comprises at least one mechanical-electrical converter. In this way, a deformation and/or force measurement is performed directly in the region in which the brake force is transmitted to the braked wheel. A very precise measurement is thus obtained without having to provide a force sensor in the actuator.

The arrangement of the sensor element can be selected such that the construction of existing electromechanical brakes requires no, or only minor, alteration.

Moreover, as a result of such a sensor element, continuous monitoring of the brake is possible during each braking procedure.

The control unit is therefore advantageously designed such that the data delivered by the sensor element may be stored in a memory, from which it may be read out for maintenance and evaluation purposes. Moreover, the control unit may be configured such that a warning message is output if a fault is detected.

If the recorded data are stored, it is also possible to evaluate the data in relation to relatively long time periods. For example, conclusions may be made about the state of wear of the brake pad of the brake shoe, about the driving behaviour in general or faults occurring in the brake. The data delivered by the sensor element may be entered into a vehicle self-diagnostics system, for example, so that the thus possible long-term monitoring enables any faults which occur to be detected in the preliminary stages or at least as early as possible. Plausibility considerations may also be made on the basis of stored data here.

The respective evaluation may possibly take place via artificial intelligence.

It would also be conceivable to use these data together with other vehicle data, for example relating to vehicle speed, the course of the road and the slope of the road, to control autonomous or partly autonomous vehicle systems.

The possible continuous monitoring also improves the integration of the electromechanical brake in an energy monitoring system of an electrically driven vehicle, for example in association with controlling the recuperation of electric energy during braking procedures.

The sensor element comprises at least one strain gauge. On the one hand, strain gauges are flat, which facilitates their integration in the region of the brake shoe. On the other, they are cost-effective and also durable, since they have no mechanically moving parts. The strain gauges can also be used under the high temperatures which occur in electromechanical brakes. Strain gauges enable precise deformation measurement and therefore precise recording of the brake force in the region of the brake shoe.

In one exemplary arrangement, two separate strain gauges are advantageously arranged adjacent to one another in a plane in order to obtain a statement about the spatial distribution of the applied brake force in the surface of the brake shoe. Moreover, a certain redundancy for the sensor element can be established in this way. It is, of course, also possible to use only one, or more than two, strain gauges or other suitable deformation sensors.

In a possible variant, the sensor element comprises a temperature sensor in addition to the at least one mechanical-electrical converter. A small and cost-effective temperature sensor can be easily integrated in the sensor element. In this way, additional information about the behaviour of the electromechanical brake can be obtained and possible faults, for example due to frequently elevated temperatures, can already be detected in the preliminary stages.

In order to ensure that the data transfer is as error-free as possible, the sensor element may be connected to the control unit of the electromechanical brake via an electric line.

To this end, for example, a conventionally present electric line to a wear sensor can be used, via which the data of the sensor element may possibly be transmitted in addition to the data of the wear sensor. Additional costs are not incurred in this case.

Alternatively, wireless, for example radio-based, data transmission from the sensor element to the control unit is, of course, also conceivable.

The sensor element may be secured on the brake shoe or integrated in the brake shoe, for example. In these cases, the sensor element is replaced together with the brake shoe. In this exemplary arrangement, the electromechanical brake requires no, or only minor, adaptation.

In another exemplary arrangement, the sensor element is arranged on the brake calliper in a fixed and permanent manner. In this case, conventional brake shoes may be used as replacement parts, whilst only one sensor element is normally required over the useful life of the brake.

The sensor element can be arranged, for example, on a rigid flat carrier plate, which only takes up a small amount of space on the brake calliper so that the conventional electromechanical brake requires only minor adaptation.

A brake shoe for an electromechanical brake is also disclosed herein. An exemplary brake shoe has a rigid backplate and a brake pad, which is connected to the backplate in a fixed manner and comes into contact with the brake disc, wherein a sensor element, which comprises at least one mechanical-electrical converter, is arranged between the backplate and the brake pad. The sensor element is therefore also replaced with each change of brake shoe. There is therefore no need to worry about wear on the sensor element over the useful life of the brake shoe.

During the production of the brake shoe, the sensor element is integrated therein in that it is arranged between the backplate and the brake pad and, for example, crimped and/or bonded to the brake pad and the backplate. By securing the brake pad to the backplate, the sensor element is also secured in the brake shoe in a fixed and non-displaceable manner.

A brake shoe unit for an electromechanical brake is also disclosed herein. More specifically, the brake shoe has a rigid backplate and a brake pad connected to the backplate in a fixed manner, and the sensor element, which comprises at least one mechanical-electrical converter, is arranged on a carrier plate, which is connected to the backplate of the brake shoe in a fixed manner. This may take place, for example, by crimping and/or bonding the carrier plate to the backplate or by another suitable fastening method. The carrier plate is preferably thin and flat, so that the brake shoe unit only has a slightly greater thickness than a conventional brake shoe or the backplate may be reduced by the thickness of the carrier plate. In this case, it is possible to use a conventional brake shoe, on the backplate of which the carrier plate is mounted, the sensor element being secured on the said carrier plate in a fixed manner.

The sensor element can be easily pre-mounted on the carrier plate so that the assembly comprising the carrier plate and sensor element only has to be connected to the brake shoe in order to produce the brake shoe unit.

The carrier plate is normally connected to the backplate of the brake shoe in a fixed manner and such that it cannot be released without destruction. The brake shoe unit is installed in the electromechanical brake in place of a conventional brake shoe.

By way of example, in such a brake shoe or such a brake shoe unit, the sensor element is connected to a plug component held on a circumferential edge of the brake shoe or, accordingly, the brake shoe unit, as is conventionally known for wear sensors, so that an electrical connection to the control unit of the electromechanical brake can be easily produced via a suitable cable.

The brake shoe or the brake shoe unit may additionally have a conventional wear sensor. However, the function of the wear sensor may optionally also be assumed by the sensor unit. It is then possible to dispense with an additional wear sensor, which lowers costs.

### BRIEF DESCRIPTION OF THE DRAWINGS

The disclosure is described in more detail below with the aid of multiple exemplary arrangements and with reference to the accompanying figures. In the figures:

FIG. 1 shows a schematic perspective illustration of an electromechanical brake according to the disclosure;

FIG. 2 shows two variants of a brake shoe unit according to the disclosure, in a schematic perspective illustration;

FIG. 3 shows a brake shoe according to the disclosure, in a schematic perspective illustration;

FIG. 4 shows a brake shoe unit according to the disclosure, in a schematic perspective illustration; and

FIGS. 5 and 6 each show a carrier plate with a sensor element and a brake shoe of the electromechanical brake of FIG. 1.

### DETAILED DESCRIPTION

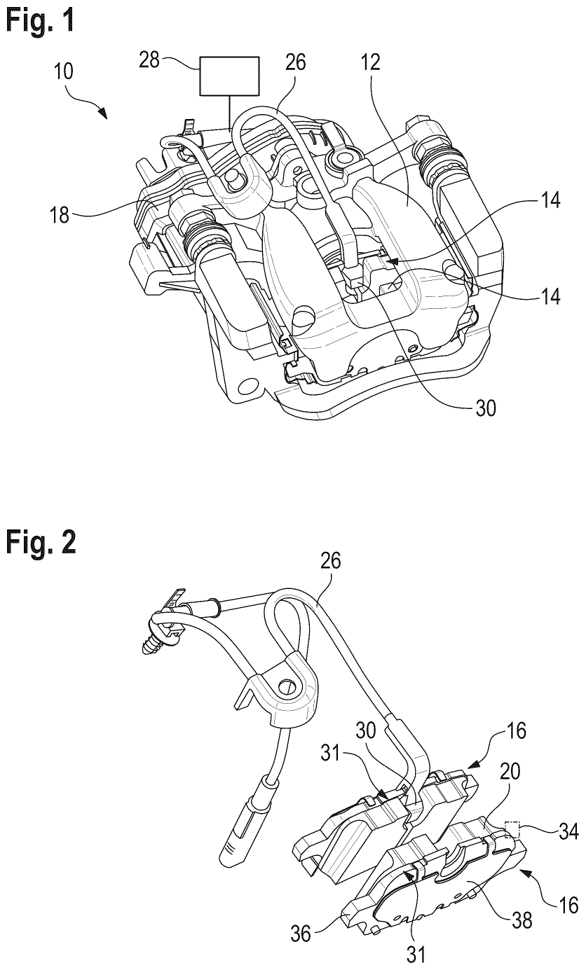

FIG. 1 shows an electromechanical brake 10, which is designed as a brake of a vehicle wheel here.

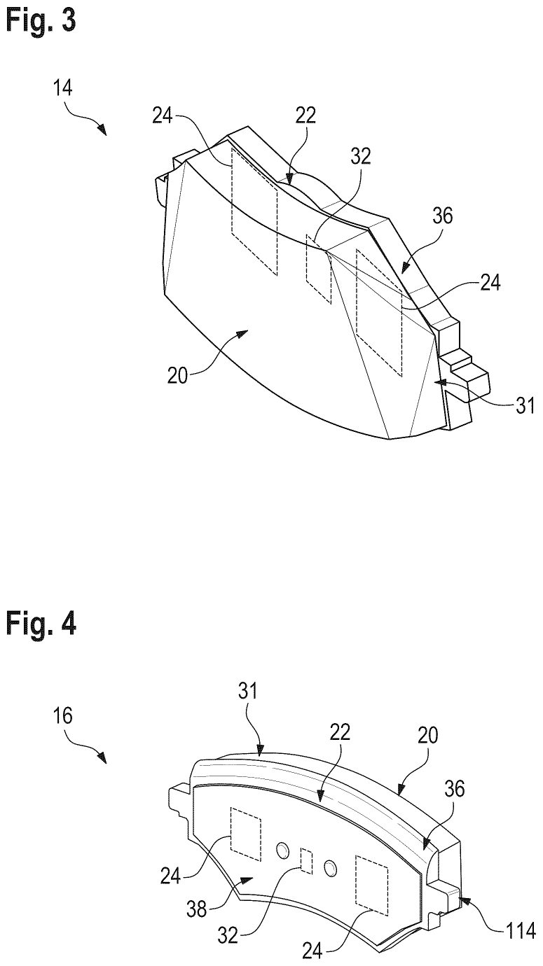

The electromechanical brake 10 comprises a brake calliper 12, in which a brake rotor (not illustrated and also referred to as a brake disc here) is accommodated, which brake rotor cooperates with a brake shoe 14, 114 or a brake shoe unit 16 (see FIGS. 3, 4 and 6) on both sides. For illustrative purposes, two brake shoes 14 are shown in FIG. 1. However, it would be equally possible to mount two brake shoe units 16 or two conventional brake shoes 114. A mixed arrangement would also possibly be conceivable.

An actuator unit 18 is arranged on the brake calliper 12, which actuator unit comprises an actuating element (not illustrated), which is accommodated in the brake calliper 12 and cooperates with the brake shoe 14, 114 or the brake shoe unit 16 in order to move the brake shoe 14, 114 or the brake shoe unit 16 towards the brake disc. The actuating element here is a brake piston, which is displaced linearly in a known manner in order to press a brake pad 20 of the brake shoe 14, 114, or of the brake shoe unit 16, against the brake disc and thereby generate a brake force for decelerating a vehicle wheel.

The electromechanical brake 10 comprises a sensor element 22 (see FIGS. 3 to 5), which contains at least one mechanical-electrical converter 24. In these examples, two mechanical-electrical converters 24, arranged in a plane and flatly adjacent to one another, are present in each case. The mechanical-electrical converters 24 here are each designed as strain gauges.

The sensor element 22 records, for example, a mechanical deformation of the mechanical-electrical converter 24, which, amongst other things, represents a measure of a current brake force and converts this into an analogue or digital electrical signal.

In the exemplary arrangement illustrated in FIGS. 1 and 2, this signal is transmitted via an electric line 26 to a control unit 28 of the electromechanical brake 10, in which it is processed and, in this example, also stored. The control unit 28 may belong exclusively to the electromechanical brake 10, for example in that the control unit 28 is integrated in the actuator unit 18, or it may be part of the vehicle electronics in general.

In this example, the electric line 26, as is conventionally known, is designed for connection to a wear sensor (not illustrated) on the brake shoe 14. In a possible option, the brake shoe 14 or the brake shoe unit 16 has such a wear sensor in addition to the sensor element 22, the data of which wear sensor are transmitted to the control unit 28 via the electric line 26. In another possible option, the sensor element 22 also assumes the function of the wear sensor, and the control unit 28 also ascertains a current state of the brake pad 20 in addition to a current brake force, e.g. from the data transmitted by the sensor element 22.

A plug component 30 is arranged on the brake shoe 14 or the brake shoe unit 16, in this exemplary arrangement on a longitudinal side of a circumferential edge 31 of the brake shoe 14 or, accordingly, the brake shoe unit 16, to which the electric line 26 may be connected.

In the exemplary arrangements shown here, the sensor element 22 optionally comprises a temperature sensor 32 in addition to the mechanical-electrical converter 24, the data of which temperature sensor are likewise transmitted to the control unit 28.

FIG. 2 additionally shows another exemplary arrangement, in which the data transmission from the sensor element 22 to the control unit 28 takes place wirelessly via a radio transmission module 34.

The sensor element 22 is arranged in the region of the brake shoe 14, 114 in all exemplary arrangements. This should be understood such that the sensor element 22 is integrated in the brake shoe 14 or is in direct contact with the brake shoe 114 in the brake 10.

In the exemplary arrangement shown in FIG. 3, the sensor element 22 is integrated in the brake shoe 14 in that it is arranged between the brake pad 20 and a rigid backplate 36 of the brake shoe 14. During the production of the brake shoe 14, the brake pad 20 is connected to the backplate 36 in a fixed manner, for example by crimping and/or bonding. In this process step, the sensor element 22 is placed between the backplate 36 and the brake pad 20 and fixed in the desired position in the brake shoe 14 due to the connection between the brake pad 20 and the backplate 36.

The brake shoe 14 is installed in the electromechanical brake 10 in place of a conventional brake shoe 114 and is suitably connected to the control unit 28 for power supply and data transmission purposes.

In the exemplary arrangement shown in FIG. 4, the sensor element 22 is secured on a conventional brake shoe 114 and connected thereto in a permanent manner to form a brake shoe unit 16. The brake shoe unit 16 is produced in that a conventional brake shoe 114, including a brake pad 20 and a backplate 36, is connected to a separate thin, and in one exemplary arrangement, rigid, carrier plate 38 on which the sensor element 22 is secured. The carrier plate 38 is connected directly to the backplate 36 in a fixed manner, for example by bonding, welding or a screw connection, wherein the sensor element 22 is placed between the carrier plate 38 and the backplate 36.

The brake shoe unit 16 is installed in the electromechanical brake 10 in place of a conventional brake shoe 114.

In the case of both the brake shoe 14 and the brake shoe unit 16, the sensor element 22 cannot be removed without destruction.

In these two variants, the sensor element 22 is also replaced when a brake shoe 14 or the brake shoe unit 16 is changed. The backplate 36 and the brake pad 20 require only minor adaptation with respect to conventional brake shoes 114.

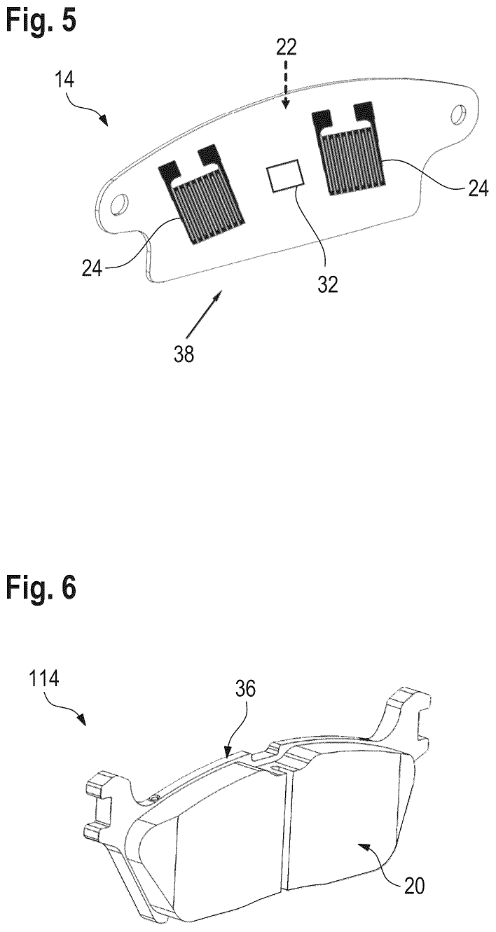

In the variants shown in FIGS. 5 and 6, the sensor element 22 is mounted on the brake calliper 12 in a fixed and permanent manner.

As in the case of the brake shoe unit 16 described above, the sensor element 22 here is mounted on a thin, for example, rigid carrier plate 38. However, unlike the case of the brake shoe unit 16, this carrier plate 38 is not connected in a fixed manner to the brake shoe 114, but is instead secured in a fixed manner to the brake calliper 12. The position here is selected such that the brake shoe abuts against the carrier plate 38 with its backplate 36, so that the sensor element lies between the carrier plate 38 and the backplate 36.

In this case, a conventional brake shoe 114 without a sensor element 22 is used. If the brake shoe 114 has to be changed, it is replaced by a new conventional brake shoe 114, whilst the sensor element 22 remains fixed on the brake calliper 12 and is not replaced.

In all exemplary arrangements, the brake force acting on the brake disc and the brake shoe 14, 114 or the brake shoe unit 16 is transmitted to the sensor element 22 and brings about a deformation of the mechanical-electrical converter 24 there, which generates a signal. This signal is transmitted to the control unit 28 and suitably evaluated there.

All features of the individual arrangements and variants are freely interchangeable or can be combined with one another at the discretion of a person skilled in the art.

For reasons of clarity, identical components are not always denoted by reference signs.

1. An electromechanical brake for a vehicle, comprising an actuating element, which is accommodated on a brake calliper in a linearly displaceable manner and cooperates with a brake shoe which can be moved towards a brake disc, wherein a sensor element is arranged in a region of the brake shoe, the sensor element being designed such that it transfers data to a control unit of the electromechanical brake, wherein the sensor element comprises at least one mechanical-electrical converter.

2. The electromechanical brake according to claim 1, wherein the sensor element comprises at least one strain gauge.

3. The electromechanical brake according to claim 1, wherein the sensor element comprises a temperature sensor.

4. The electromechanical brake according to claim 1, wherein the sensor element is connected to the control unit of the electromechanical brake via an electric line.

5. The electromechanical brake according to claim 4, wherein the electric line is connected to a wear sensor on the brake shoe.

6. The electromechanical brake according to claim 1, wherein the sensor element is secured on the brake shoe or integrated in the brake shoe.

7. The electromechanical brake according to claim 1, wherein the sensor element is arranged on the brake calliper in a fixed and permanent manner.

8. A brake shoe for an electromechanical brake according to claim 1, having a rigid backplate and a brake pad, which is connected to the backplate in a fixed manner and comes into contact with the brake disc, wherein the sensor element, which comprises at least one mechanical-electrical converter, is arranged between the backplate and the brake pad.

9. A brake shoe unit for an electromechanical brake according to claim 1, having a brake shoe, which has a rigid backplate and a brake pad connected to the backplate in a fixed manner, wherein the sensor element, which comprises at least one mechanical-electrical converter, is arranged on a carrier plate, which is connected to the backplate of the brake shoe in a fixed manner.

10. The brake shoe according to claim 8 wherein the sensor element is connected to a plug component held on a circumferential edge of the brake shoe.

11. The electromechanical brake according to claim 2, wherein the sensor element comprises a temperature sensor.

12. The electromechanical brake according to claim 11, wherein the sensor element is connected to the control unit of the electromechanical brake via an electric line.

13. The electromechanical brake according to claim 11, wherein the sensor element is secured on the brake shoe or integrated in the brake shoe.

14. The electromechanical brake according to claim 5, wherein the sensor element is arranged on the brake calliper in a fixed and permanent manner.
